(19) United States
(12) Patent Application Publication
(10) Pub. No.: US 2021/0139219 A1
(43) Pub. Date: May 13, 2021

(54) HOLDERS, HOLDER STRIPS AND A CULTIVATION-, PACKAGING- AND SHIPPING SYSTEM AND METHOD FOR PLUGS

(71) Applicants: VISSER 'S-GRAVENDEEL HOLDING B.V., 's-Gravendeel (NL); HISHTIL LTD., Moshav Nehalim (IL)

(72) Inventor: Anthony VISSER, 's-Gravendeel (NL)

(21) Appl. No.: 16/606,319

(22) PCT Filed: Apr. 19, 2018
(86) PCT No.: PCT/EP2018/060103

§ 371 Date: Oct. 18, 2019

(30) Foreign Application Priority Data
Apr. 20, 2017 (CN) 201710261535.8

(51) Int. Cl. B65D 77/04; B65D 85/52; B65D 25/10; B65D 81/26; B65D 77/20; A01G 9/029

(52) U.S. Cl. CPC B65D 77/04; B65D 85/52; B65D 25/103; A01G 9/0295; B65D 77/2024; A01G 9/0299; B65D 81/263

(57) ABSTRACT

The embodiments of the present invention relate to the cultivation-, packaging-, and shipping of plugs, containing a seed or seedling and a substrate. In particular, a holder (10) is contrived having one or multiple cavities (11) in which a plug can be placed, together with one or multiple removal slits (12). Furthermore, a packaging tray (30) is contrived, having engaging means (32) and a perforated foil, to be used in unison with a particular holder for shipping that particular holder to a retailer or a customer. The holder could be placeable in both a cultivation tray (80) and a packaging tray (30).

### TECHNICAL FIELD

The invention generally relates to holders, holder strips, and cultivation-, packaging- and shipping apparatuses, systems and methods for plugs.

### BACKGROUND OF THE INVENTION

Conventionally, in a cultivation-, packaging- and shipping process of plugs an operator at the start of the cultivation process grows plants in a special cultivation pot, and then transports the young plants to a grower who grows the plants to specific plant pot dimensions. This second grower transports the grown young plants to an exporter. The exporter transports the plants to a retailer who sells the plants to customers. Because this process has a lot of links, the customer pays a higher price at the end of the chain.

Conventional packaging means for plugs suffer drawbacks as well. These often cannot be shipped via ordinary mail or package delivery services, since the plugs are not securely fastened in the packaging means, because the size and shape of the package does not allow for delivery or because the package does not provide an environment in which the plants can thrive and survive.

Furthermore, when changing pots during this cultivation-, packaging- and shipping chain, the plants are removed from their respective holders by a pulling force exerted on the plants. This often leads to a loss of substrate still present in the holder after the removal process is complete and sometimes even inflicts damage to the plugs or plants. For example, leaf damage can occur, damage to the roots, et cetera. Especially inexperienced customers might inflict this kind of damage on the plants, if there is no other way to remove the plugs from their holders in their entirety.

Also, when handling a plurality of such holders, it is often time consuming to remove each holder separately from for example a cultivation tray.

On the other hand end consumers often buy a plurality of one particular plant.

Due to the above-mentioned reasons, existing methods in the cultivation-, packaging- and shipping of plugs do not allow for shipping in a reliable and fast way. Furthermore, the conventional chain from grower to customer has a plurality of links that can be removed when the shipping and packaging is done in a secure and reliable way. Finally, plugs removed from their holders often suffer damage with existing designs of holders.

### SUMMARY OF INVENTION

It is therefore an objective to reduce any of the above or other drawbacks of the conventional cultivation-, packaging- and shipping apparatuses, systems and methods.

A first aspect of the invention relates to a packaging device used to transport one or more plugs or one or more plants. The packaging device comprises a container, such as a tray. The packaging device comprises perforated foil and one or multiple holders for one or multiple plugs or plants. The container comprises a bottom surface and a wall forming a receiving space with an opening the top. Perforated foil is adhered to the container so to seal off the receiving space holding the one or multiple holders contained by the tray.

In embodiments each holder can have one or multiple cavities. The holder can be a holder strip having a row of holders, each holder formed by a cavity. The row extends in a longitudinal direction. In each cavity a plug can be received.

The bottom surface and/or the wall of the container and/or the holder can have an engaging system for detachably clamping one or multiple holders in place, such that the one or multiple holders are placed in the container with the longitudinal direction of the cavities extending generally along the bottom.

The container, preferably formed by a tray, could have one or multiple separation walls extending from the bottom surface, thus dividing the cavity of the tray into multiple compartments; each compartment having engaging means on the bottom surface or the wall for detachably clamping one or multiple holders placed in a particular compartment.

The one or multiple holders present in the tray could be sandwiched between the perforated foil and the container. This provides further fixation of the position of the holder during transport.

A wrapping material could be placed around the tray, for further protection, the wrapping material having one or multiple air holes.

The holder can be a holder strip comprising a row of holders or cells, each holder or cell having a cavity for receiving a plug. In embodiments the holder strip has two-cell units. Two cells form a unit connected by a breakable connection to another two cell unit. The two cell unit itself is internally connected by a ridge bridge.

The engaging system of the packaging device could be formed as a integral part of the packaging and is arranged to hold, preferably clamp, the holder strip at multiple locations along the joining direction. In embodiments one or more two cells unit of a holder strip is held in the packaging device. The two cell units are separated by breaking the breakable bridge from the holder strip.

A second aspect of the invention relates to a cultivation-, packaging-, and shipping system comprising a cultivation tray, a container, and a holder. The holder is arranged to be received in the cultivation tray and in the container. The holder can be transferred from the cultivation tray into the container. The content of the holder, one or more plugs or one or more plants, can remain in the cavity of the holder. The cultivation tray can have recesses for receiving the holder. The holders are held in a shape releasing manner in compartments or recesses of the cultivation tray. The container and the holder can have an engaging system for clamping and holding the holder in place in the container.

The holder can have one or more cavities. In an embodiment the holder has a row of cavities extending in a longitudinal direction, each cavity for receiving a plug. The cultivation tray can have compartments for receiving multiple holders or one or more holder strips. A plug can be placed in the cavity of the holder, the holder received in a recess of the cultivation tray. This allows for cultivation of a seed, seedling or plant present in the substrate placed in the holder. In the early stages of development of a seed, seedling or plant, the plant is growing in substrate held in the cavity of the holder that in turn is held in the cultivation tray.

The container, e.g. a packaging tray, can comprise a bottom surface and a wall forming a receiving space. The receiving space can have an opening at the top. A perforated foil can seal off the receiving space, after fixing the position of the holder with plugs in the receiving space. The perforated foil can be adhered to the container.

The container and the holders have an engaging system for fixing the holder in the receiving space. The bottom surface or the wall of the packaging tray could have engaging means for detachably clamping one or multiple holders in place such that the one or multiple holders are placed with the longitudinal direction of the holder parallel to the perforated foil.

The holder with cavities or several holders with cavities can be transferred after the plug reaching a certain threshold development from the cultivation holder into the receiving space. The plug is held in the same cavity before and after transfer. The plug is less disturbed.

A third aspect of the invention relates to a cultivation-, packaging-, and shipping method. The method comprises cultivating a seed, seedling, a plant or plant with substrate in a cavity of a holder. Multiple holders are held by a cultivation tray during the cultivation process. The cavities of the holders are filled with one or more substrates with one or more seed, seedling or plant at the beginning of the cultivation process, preferably when the holders are already held in the cultivation tray.

The method comprises cultivation of the seeds, seedlings or plants in each holder for a period of time. In a next phase of the cultivation process, the holders with plug (developed seed, seedling or plant with substrate) are separated, e.g. removed from the recesses of the cultivation tray and subsequently engaged and detachably clamped in a receiving space of a container, such as a packaging tray. The container/packaging tray is sealed off by a perforated foil and shipped, e.g. directly to an end user. One or more holders are received in the container.

A fourth aspect of the invention relates to a holder strip of several holders each having a cavity, the cavity forming a row in a joining direction, the cavities arranged for receiving an object such as a plug and the cavities extending in a longitudinal direction perpendicular to the joining direction. The one or more cavities have a wall, surrounding the cavity. Each wall has one or more removal slits interspersing the wall, surrounding the cavity. Each such removal slit extends in the longitudinal direction, starting at the top of the cavity and arranged to allow an operator to engage an object placed inside the cavity and to remove it from the cavity via a motion in the longitudinal direction. Each removal slit should have a length larger than 30%, preferably 50 percent, of the length of the wall in the joining direction.

Each cavity could be concatenated with adjacent cavities by means of a bridge, extending between the cavities. Furthermore, the removal slits could be formed on opposite sides of a cavity. If the cavity has a bottom surface, the bottom could have one or more draining holes formed in its surface. In an embodiment the holder strip has a unit of two cells connected by a bridge, wherein the two cell unit is connected to a further two cell unit by a breakable bridge.

Any feature disclosed herein, part of any of the disclosed aspects, can be combined to form an embodiment according to this disclosure.

### BRIEF DESCRIPTION OF DRAWINGS

Embodiments will now be described, by way of example only, with reference to the accompanying schematic drawings in which corresponding reference numbers indicate the same or corresponding elements, and in which:

FIG. 1 schematically shows a perspective view of an embodiment of a holder strip according to the present invention, with multiple cavities and removal slits.

FIG. 2 schematically shows a perspective view of an embodiment of the present invention, showing one holder with two removal slits.

FIG. 3A shows a perspective view of a holder strip having breakable bridges, such that the holder strip can be divided into cells having two holders each connected by a rigid connection.

FIG. 3B shows a side view of a holder strip having breakable bridges, such that the holder strip can be divided into cells having two holders each connected by a rigid connection.

FIG. 3C shows a top view of a holder strip having breakable bridges, such that the holder strip can be divided into cells having two holders each connected by a rigid connection.

FIG. 3D shows a cross section along line A-A of the rigid connection between two holders in a cell.

FIG. 3E shows a cross section along line B-B of the breakable bridge between two cells.

FIG. 3F shows a cross section along line C-C of the breakable bridge between two cells.

FIG. 3G shows a detailed view of the breakable bridge between two cells.

FIG. 3H shows a detailed view of the rigid connection between two holders in a cell.

FIG. 4 shows a perspective view of an embodiment of the present invention.

FIG. 5A shows a perspective view of a container with holders according to an embodiment of the present invention.

FIG. 5B shows a perspective view of another embodiment of a container with holders according to the present invention.

FIG. 5C shows a perspective view of another embodiment of a container with holders according to the present invention.

FIG. 6 shows a perspective view of an embodiment of the present invention, a packaging tray is shown having multiple compartments with placed therein, no seal is shown.

FIG. 7 shows a perspective view of an embodiment of the present invention, a wrapping means is shown, placed around a packaging tray, with air holes.

FIG. 8A shows a perspective view of an embodiment of the present invention, a cultivation tray is shown, without holders present.

FIG. 8B shows a perspective view of an embodiment of the present invention, a cultivation tray is shown, without holders present.

FIG. 9 is a block diagram, showing a particular cultivation-, packaging- and shipping method.

The figures are meant for illustrative purposes only, and do not serve as restriction of the scope or the protection as laid down by the claims. Any of the features disclosed in the figures and/or in the description can be taken in isolation unless explicitly indicated that it cannot. Any feature in the figures and description having an explicit or implicit advantage can be the basis for a divisional application.

### DESCRIPTION OF EMBODIMENTS

FIG. 1 schematically shows an embodiment of a holder according to the invention.

Holder strip 10 can hold plugs used in cultivation and gardening. Holder strip 10 consists of a row of holders, concatenated in a joining direction 20, thereby forming a strip of holders. Each holder has a cavity 11 that has a bottom surface 17 and walls 16. Cavity 11 starts at the opening 15 and extends towards the bottom surface 17 in the longitudinal direction 21.

In each cavity 11 of the holder 10 a plug of a substrate and a seed, seedling, plant cutting or fully grown plant, can be placed by an operator, such as for example a grower. A plant can denote any part of the plant. The placing motion is in the longitudinal direction 21. The young plant could be in the embryogenesis or organogenesis phase of its development. The plant could also be fully grown. The substrate can be a mixture of for example ground, potting soil, dirt, water and minerals.

Each holder of the strip holder 10 is joined with an adjacent holder via a bridge 14 consisting of a top connection, spanning between the openings 15 of two adjacent holders. The bridges 14 might have the same width in a direction perpendicular to the joining direction 20 and the longitudinal direction 21 as the diameter of the opening 15. In this way, the strip 10 can withstand larger internal- and external stress. Furthermore, a bridge 14 may have a lip that allows breaking and can be formed via a flat connecting surface or a curved connecting surface.

A bridge might have an extra support structure apart from the top connection, to make sure that the strip 10 is strong enough to support its own weight when filled with one or multiple plugs. This support structure might be attached to the bridge 14 or one of the walls 16 of the two holders connected via the bridge 14.

The bridge 14 may also be spanned between the bottom surfaces 17 of two adjacent holders forming a bottom connection, or any place on the walls 16 of the two adjacent holders forming a wall connection. Furthermore, two adjacent holders may be connected at different heights in the longitudinal direction 21.

The bridges 14 allow for a certain space between each pair of adjacent holders, that can be used by for example engaging means to grip the strip 10 via the space freed by the bridges 14. Furthermore, it becomes easier to handle the strip 10 without touching the plugs, by lifting the strip 10 via the bridges 14.

A bridge 14 does not necessarily have to be a spacer between two adjacent holders. The walls 16 of each adjacent holder are formed to be in contact with each other via the bridge 14. If the walls 16 of both holders separately converge towards each other in the longitudinal direction 21, space is freed between each holder in this way, which again can be used by for example engaging means to grip the strip 10.

The strip 10 might have handles protruding from one or more walls 16 of any one of its holders, for more easier handling by an operator. For example, the strip 10 having handles protruding on both extremities of the strip 10 in the joining direction 20 is easily picked up and transported by an operator.

The wall 16 of each holder is interspersed by removal slits 12. The removal slit 12 separates two wall portions 23 and 24 to allow easy access to the plug placed in the cavity 11. An operator, such as an end user, is able, when in the process of removing a plug from the cavity 11, to engage the plug via the access points that the removal slits 12 open up. This allows the operator to remove the plug from the cavity 11 without pulling on the seedling or plant, allowing for a more secure removal process. Furthermore, by directly applying a force on the substrate of the plug the operator can assure that the entirety of the substrate is removed during the removal process.

The removal slits 12 are surrounded by edges 25 of the opening 15, such that the edge 25 at the opening 15 is interrupted by the removal slits 12. This means that the operator, when placing or removing the plug using the removal slits 12, does not encounter an opening edge 25 formed by the walls 16, present at the opening 15. This allows the operator to perform a single removal motion in the longitudinal direction 21. Hence, the removal process is simplified and the chance of damaging the plant or the substrate is greatly decreased. Furthermore, because the removal process is done in one motion, the removal process is faster than when multiple steps have to be performed. Furthermore, it becomes easier for mechanical means, automated or not, to place and remove the plug in and from the holder without damaging the plant or substrate. Since the removal process is less complicated, the mechanical means needed for the placement and removal process can be cheaper.

Two removal slits 12 are formed on opposing sides of the wall 16. This allows for a more supported placement- and removal process. By being able to apply a force on both sides of the plug, the plug can be effectively grabbed. More than two removal slits 12 can be present in a single holder. It is also possible to have a single removal slit 12 present on a holder. The operator can in this case apply a force via the removal slit on the substrate, and using frictional forces slide the plug in or out of the cavity 11 in a placement- or removal process respectively.

The distance in the longitudinal direction 21 starting at the opening 15 of the cavity 11 until the end of the removal slit 12 is called the length of the removal slit 12. The length of the removal slit 12 should be long enough such that the plug present in the cavity 11 can be effectively grabbed. If the length of the removal slit 12 is insufficient, friction forces acting on the plug might be too large and the plug cannot be efficiently released.

The length of the removal slit 12 may be larger than 10 percent of the total distance between bottom 17 and opening 15, more preferably larger than 30 percent, even more preferably larger than 50 percent, better yet larger than 70 percent. The choice for the length of the removal slit 12 may depend on for example the composition of the substrate. When a substrate is very cohesive, a shorter length of the removal slit 12 will suffice since the substrate will not break as fast during the removal process.

The removal slit 12 does not need to be formed only in the longitudinal direction 21, but can, apart from the necessary length in the longitudinal direction, also be formed partially in the joining direction 20. The removal slit 12 may have a spiral shape, an inclined shape or any other shape. A benefit of having been formed in the joining direction 20 is that via a turning motion of the plug, the plug is more easily removed when stuck in the cavity 11, without destroying the substrate.

The wall 16 connects the bottom surface 17 of the holder with the edge 25 of the opening 15 of the cavity 11. Its surface may have any three-dimensional shape, and might be for example dividable in multiple faces via a number of edges. The walls 16 define the edge 25 of the opening 15 of the cavity 11, and this edge 25 can have any shape because of this.

The wall 16 may be strengthened by means of a reinforcing wall or a reinforcing edge. This makes sure that the wall 16 will withstand internal and external stress, regardless of the lengths of the removal slits 12.

The length of the strip 10 depends on the number of holders present on the strip 10, which can range between 2 and 40, between 5 and 30 and between 10 and 20 holders for example.

The bottom 17 may have a draining hole 13, to protect the plant from overwatering. The draining hole 13 allows excess water to exit the cavity 11 of a holder, plants are thereby protected from rot, fungus and bacteria. A holder may have multiple draining holes 13. Furthermore, each draining hole 13 may have a circular, rectangular, square, polygonal or any other two-dimensional shape in the plane parallel to the bottom surface.

In the description above an embodiment has been described where each holder of the holder strip 10 has a bottom surface 17. While retaining all other properties, having a bottom 17 is not necessary. By shaping the wall 16 of a holder such that it for example converges in the joining direction, a plug will effectively be supported by the walls 16 without a bottom surface present. The obtained opening opposing the opening 15 in this manner can be used by an operator to push the substrate out, while still supporting- and guiding the substrate via the removal slits 12.

The edge 25 of the opening 15 can have an extra circumferential edge formed in the direction outwards from the cavity 11. This allows for easier access of the plug into the cavity 11, since the opening 15 will have a larger diameter.

The strip 10 can be fabricated from any material suitable for receiving a plug and cultivating a seed or seedling present in the substrate therein. This includes for example different forms of plastic or any other kind of synthetic or semi-synthetic organic compound. The strip 10 can be for example constructed using fabrication methods common in the field of packaging. This includes thermoforming and injection molding.

The holders strip 10 can have a clicking or joining system that would enable the strip 10 to be fastened in a detachable way to any sort of engaging system, for example present in a container, packaging tray or a cultivation tray.

As shown in FIG. 2, a holder 27 can also exist on its own without being formed in a strip 10, and a skilled person will understand that all or a selection of the described properties for a holder present in a strip 10 described in the previous embodiment can be retained for a singular holder 27.

The holder 27 consists of walls 16 and a bottom surface 17, forming a cavity 11. The wall 16 of the holder 27 is interspersed by removal slits 12. The removal slit 12 separates two wall portions 23 and 24 to allow easy access to the plug placed in the cavity 11. A holder 27 can have one, two or more removal slits 12 present. The removal slits 12 are surrounded by edges 25 of the opening 15 of the holder 27, such that the edge 25 at the opening 15 is interrupted by the removal slits 12. In this way, the operator can remove the plug present in the holder 27 in one motion, without the motion being interrupted by the edge 25 of the opening 15.

A holder 27 can have one or multiple handles, fixed to its walls 16, its opening edge 25 or its bottom surface 17. This allows an operator to pick up and place a holder 27, even when the weight or shape of the holder 27 does not allow for easy handling using walls 16, opening edge 25 or bottom surface 17 alone.

The bottom surface 17 can have a draining hole 13, for draining excess water from the cavity 11. Again however, as in the previous embodiment, a bottom surface 17 is not a necessity. The walls 16 can be formed to support the plug, for example by having a converging shape in the longitudinal direction 21. The holder 27 will then be formed by walls 16, having the removal slits 12 present.

FIGS. 3A-3H show a holder strip 10 having six holders or cells. The respective cells are connected to each other by bridges 14. In this embodiment a bridge is a rigid connection 300, or a breakable connection 301. The holder strip 10 will have two cell units.

FIG. 3A shows a perspective view of a holder strip 10. The holder strip 10 consists of multiple holders, connected via bridges 14. When a bridge 14 forms a rigid connection 300 between two holders, these two holders are part of the same cell. In FIG. 3A, three cells consisting of two holders are shown, however the number of cells in a holder strip 10 and the number of holders in a particular cell can be different. The cells are connected via bridges 14 that are breakable. These breakable bridges thus form breakable connections 301. In FIG. 3A, the number of breakable connections 301 is two, however the number of breakable connections 301 in a holder strip 10 can be different.

The breakable connections 301 thus allow for the holder strip 10 to be divided up in multiple smaller cells, which each form a holder strip 10 or a holder 27. This is thus a more flexible design for cultivation, packaging, shipment and use by the consumer. Different plants can be placed in each cell, or in each holder of a cell. Thus, holders in a holder strip 10 can be connected by a bridge 14, wherein a first bridge 301 is breakable and a second bridge 300 is reinforced. If the bridges 14 alternate between the first bridge 301 and the second bridge 300, this creates a cell with two holders, wherein the holders are connected via the second bridge 300 and the cells are connected via the first bridge 301.

FIG. 3B shows a side view of the holder strip 10. The rigid connections 300 are reinforced by a reinforcing structure 305 formed by a plate extending between the sides of the holders along the longitudinal direction 21. The reinforcing structure 305 can be made of the same material as the holding strip 10. Because of for example the reinforcing structure 305, the bridge 14 between two holders in a cell can be made to form a rigid connection 300. Other methods of forming a rigid connection 300 are also possible, including a change in material or thickness.

The breakable connections 301 are formed by a breakable structure 306 which is by design easier to break than the rigid connections 300. The breakable structure 306 is not reinforced. The breakable structure 306 can also be formed by choosing a material which is easier to break or by changing the thickness of the material at the location of the breakable connection 301.

FIG. 3C shows a top view of the holder strip 10. In this example, the reinforcing structure 305 has substantially the same width as the holder strip 10 in the direction perpendicular to the joining direction 20 and the longitudinal direction 21. In this way, the rigid connection 300 becomes less breakable. Furthermore, in this example the breakable structure 306 has a width in the direction perpendicular to the joining direction 20 and the longitudinal direction 21 which is substantially smaller than the width of the holder strip in the same direction. In this way, the breakable connection 301 still forms a connection between holders, but the connection can more easily be broken by breaking the breakable structure 306. Also, in this way while breaking the breakable structure 306, the holder strip 10 only breaks at the breakable connection 301 and further damage to the holder strip 10 is avoided.

FIG. 3D shows a sectional view along the section A-A taken from FIG. 3B. The sectional view is taken along a rigid connection 300. The longitudinal part of the reinforcing structure 305 is visible. In this example, the reinforcing structure 305 can be two plates formed in the longitudinal 21 and joining 20 directions. However, one or more plates can be used. The reinforcing structure can also be a structure elongated in the direction perpendicular to the longitudinal 21 and joining 20 directions.

FIG. 3E shows a vertical cross sectional view along the section B-B taken from FIG. 3B. The longitudinal part of the breakable structure 306 is visible. The sectional view is taken along a breakable connection 301, which is formed as a gutter or cup shaped extending between the two holders. The edge of the holder can be locally lower at the breakable connection 301. This can make the breaking at the breakable connection easier. A single leg 326 extends downwards along the side of the holder. This leg 326 provides some rigidity against undesired tearing of the breakable bridge. The legs 326, which can be view in more detail in FIG. 3C, prevent bending of the strip in the longitudinal direction.

FIG. 3F shows a sectional view along the section C-C taken from FIG. 3C. The breakable structure 306 can have a reversed V-shape and is thus not connected in the joining direction 20 between two holders. The breakable structure 306 is only connected at the breaking point of the breakable connection 301. Therefore, the breakable structure 306 is not a reinforcing structure 305 since it is not connected in the joining direction 20 along the longitudinal direction 21 apart from the breaking point of the breakable connection 301.

FIG. 3G shows a top view close-up of the breakable structure 306 at detail D in a top view taken from FIG. 3C. The breakable bridge is formed by three connections 322 that remain, while openings 320,321 forming a kind of perforation line, weakening the bridge, allowing easy breaking thereof.

FIG. 3H shows a close-up of the breakable structure 306 at detail E in a side view taken from FIG. 3E. Only one leg 326 of the reverse V-shape of the breakable structure 306 is drawn here. Furthermore, the concave shape at the top can thus lower the top edge of the holder at the breakable connection 301. Openings 320 and 321 are visible. Also leg 326 has an opening 327.

FIG. 4 shows a container formed as a packaging tray 30, to hold one or more (strip) holders for plugs, using engaging means 32. The holders used might be different than the ones described in this invention. For example, the holder may be a holder for holding a plant cutting. The cavity in this case can be the opening in which the plant cutting is fixed.

The packaging tray 30 has walls 36 and bottom surface 37, forming a cavity 31 in which one or multiple holders for plugs can be placed and securely clamped in a detachable way by means of engaging means 32. The upper edge of walls 36 in the longitudinal direction 41 is a sealing edge 45. A perforated foil (not shown) can be adhered to the sealing edge 45, to seal off the cavity 31. The packaging tray 30 provides a secure and reliable protection method for the holders present in its sealed off space. The packaging tray can then be shipped or sold via retail, without damaging the holders or the plugs present in the holders.

The engaging means 32 are formed on the bottom surface 37. Their shape depends on the type of the holders used together with the packaging tray. For example, a number of protuberances 32 can be formed on the bottom surface 37, projecting upwards in the longitudinal direction 21. These protuberances 32 support the one or multiple holders, such that they cannot substantially move in any direction in the plane defined by the bottom surface 37, defined by the arrangement direction 40 and the holder direction 42.

The holders are placed inside the packaging tray 30 by an operator, for example a grower or packager, via a motion in the longitudinal direction 41. When the holder reaches the engaging means 32, the operator places the holder in the engaging means 32. The engaging means 32 might click, clamp, support or in any other way detachably clamp the holder in its place.

The engaging system 32 can engage the one or more holders at multiple locations. The engaging means 32 do not have to be formed by means of protuberances 32 on the bottom surface 37 only, but can also be made by placing an extra upper part of the engaging means 32 on top of the holder after the holder has been placed in the lower part of the engaging means 32. The engaging means 32 thus form for example a clip or clamp, used to enclose the holder engaged by it in all directions by the upper and lower part of the engaging means 32. In this way the engaging means 32 make sure the holder cannot substantially move in the longitudinal direction 41, the arrangement direction 40 or the holder direction 42. The upper or lower part of the engaging means 32 can be made detachable from the packaging tray 30.

The engaging means 32 could also be formed by lowering certain parts of the bottom surface 37 and placing the holders inside the freed up space in this manner. In this case, the walls of these formed compartments would constitute the engaging means 32.

The engaging means 32 could not only be formed on the bottom surface 37, but also for example on the walls 36. The holders could be supported only by protuberances 32 projecting from the walls 36, depending on the orientation of the packaging tray 30 when it is shipped or sold in retail. Furthermore, engaging means 32 could be formed using protuberances 32 on both the bottom surface 37 and walls 36, in cases where the shape of the holders, the packaging tray or the shipping and selling conditions make this a necessity.

Packaging trays 30, with three different types of holders and engagement means 32 present are depicted in FIGS. 5A, 5B and 5C.

In FIG. 5A a packaging tray 30 is shown with a holder strip 10. The engagement system 32 provides support for the holder strip 10 such that the holder strip 10 cannot move in the holder direction 42 because of the engagement means 32 and the walls 36. In between two engagement means 32 there is enough room for the plant in the holder to extend outwards of the holder in the holder direction 42. The number of engagement means 32 in this example is equal to the number of bridges 14 present on the strip 10 and the strip 10 is placed such that each protuberance 32 faces a particular bridge 14.

In FIG. 5B a packaging tray 30 is shown wherein a number of separate holders 47 are depicted. On a particular row parallel to the arrangement direction 40 three holders 47 are placed at different positions in the holder direction 42. The engagement means 32 consist of a protuberance 32 placed in front of the holder 47 in the holder direction 42 and a support structure 32 placed underneath and in-between the different holders 47. The packaging tray 30 has two such row arrangements, on opposite sides of the packaging tray and the arrangements are minoring each other. Using this set-up, the holders 47 cannot move in the arrangement direction 40 or the holder direction 42. Furthermore, the space in-between the two rows of holders is used by the plants planted in the substrate of each holder 47.

Finally, in FIG. 5C a packaging tray 30 is shown in a top-view wherein two holders 47 can be placed, held in place by different engaging means 32. Only one row of holders 47 is present in the holder direction 42. Both holders 47 can be held in place by engaging means 32 formed in front, underneath and in-between the two holders 47. Furthermore, since the space opposite from the two holders 47 is not used, like in FIG. 5B, for another row of holders 47, this extra space can be used for longer plants present in the holders 47 in the holder direction 42. The height of the protuberances 32 in any of the embodiments can be for example larger than 10 percent of the height of the walls 36, or larger than 30 percent, or larger than 50 percent, or larger than 70 percent. The choice depends on the shape and size of the holders present in the packaging tray 30.

The engaging means 32 can be placed in rows or any other arrangement in any direction of the packaging tray 30, depending on the holders used together with the packaging tray 30. The engaging means 32 should allow for an easy placement- and removal process of the holders into and from the packaging tray 30.

The walls 36 have an outer side 43 and an inner side 44. The walls can have an extra support structure like ribs or an extra support band for extra protection of the packaging tray 30. The inner side 44 can be made fitting tightly against the placed holder such that the holder is kept in place by the inner side 44 of the wall 36. The outer side 43 should be relatively hard to penetrate during shipping and the retail procedure, so that the packaging tray 30 is durable in its lifetime. The same holds for the bottom surface 37. The thickness of the walls 36 and bottom surface 37 should be such that the packaging tray 30 can support its own weight when there are holders with plugs present inside the packaging tray 30.

The corners of the packaging tray 30 can be made stronger by an extra support structure or for example having rounded-off edges. This makes the packaging more durable.

The upper edge of the walls 36 in the longitudinal direction 41 is shaped as, for example, a flat surface on which a sealing edge 45 is formed. The sealing edge 45 may protrude inwards and outwards from the cavity 31 and may form a lip in either direction. The sealing edge 45 may have any shape and size, as long as it provides a way for a seal to be adhered to the sealing edge 45, to seal off the cavity 31 in a satisfying way. The seal provides a means to prevent any substrate loss of the packaging tray 30. If substrate from one of the holders is lost during shipping or in the retail process, the substrate will stay contained in the sealed off receiving space.

The seal that is adhered to the sealing edge 45 is a perforated foil. In this manner, air can pass through the seal and provide the plants in the sealed off cavity 31 with fresh air needed for the plants to survive. The perforation itself can be small enough to only let in air and not water, but can also be a bigger to also let water into the sealed off space. In principal any perforation size can be used, as long as the chosen size lets through wanted particles and stops unwanted particles. This can depend on the plants placed inside the packaging tray 30.

The seal can be for example of a transparent or semi-transparent nature, to make sure the plants present underneath the seal can absorb light. The seal can be made of for example plastic or any other kind of synthetic or semi-synthetic organic compound. Plants can grow and survive in the packaging tray 30, both with- and without the seal present.

The seal does not have to be adhered to solely the sealing edge 45, but can also be adhered to the walls 36 or the bottom surface 37 of the packaging tray 30. This leaves the packager with more freedom on which machines to use when sealing off the cavity 31 of the packaging tray 30.

Because of the seal placed over the cavity 31, the holders present in the receiving space 31 can be effectively sandwiched between the engaging means 32, the walls 36, the bottom surface 37 and the seal. In this way the seal helps with the support of the holders placed in the packaging tray 30.

The packaging tray 30 may have handles or lips protruding from any surface on the outside of the packaging tray 30, thereby making handling by an operator easier when the size, shape and weight are not ideal.

The different holders that can be placed in the packaging tray 30 can vary in size and shape. Apart from the examples already described, all holders for plugs or holders for plant(s) (cuttings) can be used, as long as the holders fit underneath the seal when sealing off the cavity 31, the holders can be used. A particular advantageous embodiment of a packaging is obtained by providing herbal plugs, preferably three different kinds in the breakable holder strips 10 having two cell units. A two cell unit containing two herbal plugs are separated from the holder strip. Three two cell units, each two cell unit containing different herbal plugs are positioned and held in a packaging tray 30. The packaging tray then has three different herbal plugs. Such a packaging tray is particularly advantageous commercially, but can be assembled at low costs according to this invention.

In FIG. 6 a packaging tray 30 is shown, having different compartments 51 for the placement of holders, detachably clamped using engaging means 32. The holders shown are strips of holders 10, described in the present invention, but can be any holders. The compartments can be divided by separation walls 56. The separation walls 56 can be used to provide support for the holders 10 present in each compartment 51. Furthermore, if the separation walls 56 are high enough, the upper edge of the separation walls 56 in the longitudinal direction 41 can be made to be a sealing edge 65, which is thus individually or all together sealed-off by means of one or multiple seals. The compartments 51 can thus be made not to communicate directly with each other, preventing for example the exchange of substrate that has been released from its respective holders 10.

Each compartment 51 should leave enough room for the holders 10 and the plants. The number of compartments 51 can range anywhere between, for example, 1 and 10.

The packaging tray 30, taken together with its seal, has a substantially cuboid form, which enables the shipping process to be performed without using wasted space. However, the shape of the packaging tray 30 is not limited to this and the packaging tray can have any three-dimensional shape, with flat and curved surfaces. The packaging tray could be able to rest on its bottom surface 37 or walls 36.

The packaging tray 30 may fit through regular mailboxes or could be send via a package delivery service, which greatly improves the ease with which the packaging tray 30 can be shipped.

In FIG. 7 a wrapping means 70 in the form of, for example, a cardboard box that surrounds a packaging tray 30 is shown. The wrapping means 70 has air holes 72 to make sure light and fresh air reaches the plants present in the packaging tray 30.

The wrapping means 70 has as its main function to further protect the packaging tray 30 during shipping and the retail process. It provides an extra layer of protection, while still enabling the plants inside to grow. Furthermore, because of the air holes 72 present on the top surface 73 of the wrapping means in the longitudinal direction 41, any person can see through the wrapping means 70 whether the plants kept inside are in a good condition or not.

In an embodiment the perforated seal is connected to the wrapping, e.g. to the cardboard. In an embodiment the cardboard and the holders have the engagement system for fixing the holders in the receiving space of the cardboard wrapping.

The wrapping means 70 can be formed of for example cardboard, stiff paper or any kind of synthetic or semi-synthetic organic compound that is easily foldable and made to surround the packaging tray 30 on all sides.

The air holes 72 can be formed such that they are in front of the plants inside the packaging tray 30, so that these plants can get the maximal amount of light and fresh air possible. However, the invention is not limited to this and the air holes 72 can be formed anywhere on the surface of the wrapping means 70.

The wrapping means 70 with the packaging tray 30 therein will during shipping most likely be stacked on top of each other, preventing the air holes 72 present on the top surface 73 of the wrapping means 70 to be effective. Therefore, air holes 72 on the side surfaces 74 of the wrapping means facing the walls 36 of the packaging tray 30 may have additional smaller air holes that provide fresh air during transport.

FIGS. 8A and 8B show cultivation trays 80, in which multiple holders or strips of holders can be placed. Each compartment or recess 82 of a cultivation tray is suitable for holding one plug. However the plug is indirectly held, as the plug is held by the holder (in its cavity) that is held in the recess 82.

Cultivation trays are used in the cultivation of the seed or seedling present in the substrate. The substrate in the holder and the holder is placed in the cultivation tray 80, such that the growing direction of the plant in the substrate is outward, away from the cultivation tray. The holder can first be placed in the cultivation tray 80 without the plug present and then later on the plug can be placed in the placed holder, or the plug can first be placed in the holder and then the holder with the placed plug can be placed in the cultivation tray 80. Holders and strips of holders, such as for example described in previous embodiments can be placed in the cultivation tray 80. The cultivation tray 80 can have draining holes in the bottom surface 87 of each of its compartments 82, but this is not a necessity. The cultivation tray 80 can have engaging means in each of its compartments 82, to detachably clamp the holders.

FIG. 8A shows a cultivation tray 80 designed for receiving a strip of holders 10 as covered by the present invention. Numerous such strips 10 with or without removal slits 12 are placed on the cultivation tray 80, each compartment 82 providing space for one holder. The bridges 14 span the space in-between two compartments 82. The strips 10 are thus securely placed on the cultivation tray 80 in an easy manner, and can also be removed in the same fashion.

FIG. 8B shows a cultivation tray 80 designed to receive separate holders 27,47, with- or without removal slits 12. Each compartment 82 of the cultivation tray 80 again provides space for one holder 27,47.

The compartments 82 of a cultivation tray 80 are made to fit around certain holders, such that during handling of the cultivation tray 80 the holders cannot substantially move sideways or outwards of the cultivation tray 80.

Cultivation trays 80 are usually made out of plastic, or any other kind of synthetic or semi-synthetic organic compound. Most cultivation 80 trays are made using thermoforming.

A holder, such as a separate holder or a strip of holders having or not having a removable slit 12, can be made receivable by both a cultivation tray 80 and a packaging tray 30. The system formed by such a holder, cultivation tray 80 and packaging tray 30 forms a cultivation-, packaging- and shipping system. The packaging tray 30 can also be used as a cultivation tray 80. The system formed by such a holder and packaging tray 30 forms a packaging- and shipping system.

The holder has one or multiple cavities 11 in which one or multiple plugs can be placed. Multiple holders can be placed in compartments 82 of the cultivation tray 80 and could for example be detachably clamped by engaging means present in each compartment 82. The holder spends a certain amount of time in the cultivation tray 80, in which time the seed or seedling present in the holder has time to grow. After a certain amount of time, each holder can be taken out of the cultivation trays 80 and placed directly, or indirectly into a packaging tray 30. The packaging tray 30 is subsequently sealed off using a perforated foil. The packaging tray 30 can then be shipped to a retailer or directly to a customer via, for example, ordinary mail or a package delivery service.

In this way, the plugs do not have to be taken out of their holders before packaging and can be simply removed from the cultivation tray 80 together with their holders and placed in the packaging tray 30. In this way, the handling is simplified.

All embodiments of the present invention can in principle be made to function together via such a cultivation-, packaging- and shipping system.

FIG. 9 shows a block diagram, describing a cultivation-, packaging- and shipping method, with steps 200, 201 and 202.

In step 200, one or multiple holder together with a plug containing a seed or seedling is placed in a cultivation tray 80, over a period of time, to allow the seed or seedling to grow. After a certain period of time has passed, in step 201 the one or multiple holders are taken out of their cultivation tray 80 and placed in a packaging tray 30, held in place by engaging means 32, and subsequently sealed off. The packaging tray 30 is then send to a customer directly via, for example, regular mail. The packaging tray 30 could also be send to a retailer.

By taking out intermediate steps of a normal cultivation-, packaging- and shipping method, the embodiment of the present invention is faster and more cost-efficient. For example, a transport phase from a grower of young plants to a grower that grows plants until they reach certain holder sizes is taken out of the cultivation chain. Furthermore, export to the exporter and from the exporter to the retailer can be taken out of the shipping chain.

The descriptions above are intended to be illustrative, not limiting. It will be apparent to the person skilled in the art that alternative and equivalent embodiments of the invention can be conceived and reduced to practice, without departing from the scope of the invention, which is defined by the claims as set out below.

1. A packaging device for transporting one or more plugs or plants, comprising:
one or multiple holders, the holder having one or multiple cavities formed in a longitudinal direction, wherein in the cavity a plug or plant is received;
a container having a bottom surface and a wall forming a receiving space for holding the one or multiple holders, and
perforated foil that seals off the receiving space, and
an engaging system arranged to detachably fix the one or multiple holders in the receiving space, the engaging system being arranged to hold the one or multiple holders with the longitudinal direction generally extending along the bottom.

2. The packaging device according to claim 1, wherein the receiving space has an opening, the opening being sealed off by the perforated foil and the longitudinal direction of the holders extending generally parallel the perforated foil.

3. The packaging device according to claim 1, wherein the container is a tray and the tray has an opening at the top,
wherein the tray has one or multiple separation walls extend from the bottom surface, dividing the cavity of the tray into multiple compartments;
the bottom surface or a wall in each compartment having engaging means for detachably clamping one or multiple holders in place.

4. The packaging device according to claim 1, wherein the one or multiple holders are sandwiched between the engaging means, the bottom surface, and the perforated foil.

5. The packaging device according to claim 1, wherein a wrapping material is placed surrounding the tray for further protection, and wherein the wrapping material has one or multiple air holes.

6. The packaging device according to claim 1, wherein the holder is a holder strip having a row of cavities extending in a joining direction, the cavity receiving the plug or plant.

7. The packaging device according to claim 6, wherein the engaging system is arranged to hold the holder strip at multiple locations along the joining direction.

8. A cultivation-, packaging- and shipping system comprising a cultivation tray, a container and a holder, the holder receivable by both the cultivation tray and the container;
wherein the holder has one or more cavities, formed in a longitudinal direction, for receiving a plug or plant;
wherein the cultivation tray having compartments for receiving multiple holders, for cultivating a seed or seedling or plant present in the holder;
wherein the container comprising a bottom surface and a wall forming a receiving space for holding the one or multiple holders, wherein a perforated foil can seal off the receiving space,
wherein the container and holder have an engaging system arranged to detachably fix the one or multiple holders in the receiving space, the engaging system being arranged to hold the one or multiple holders with the longitudinal direction generally extending along the bottom.

9. The cultivation-, packaging- and shipping system of claim 8, wherein the holder is a holder strip having a row of cavities extending in a joining direction.

10. A cultivation-, packaging- and shipping method comprising:
providing a container, perforated foil, and seeds, seedlings or plants, holders, each holder having one or more cavities, and a cultivation tray;
placing one or more seeds, seedlings or plants in the one or more cavities;
placing multiple holders in compartments of a cultivation tray;
cultivating the seeds, seedlings or plants in each holder for a period of time;
transferring the holders from the cultivation tray and detachably clamp one or multiple holders in the container,
sealing off the container with perforated foil and
shipping the packaging tray.

11. The cultivation-, packaging- and shipping method of claim 10, wherein the method further comprises breaking a breakable bridge of the holder that connects two adjacent cavities.

12. The cultivation-, packaging- and shipping method of claim 10, wherein the method further comprises wrapping the container, e.g. in a paper wrap.

13. The cultivation-, packaging- and shipping method of claim 10, wherein the shipping comprises delivering the sealed container with cultivated seed, seedling or plant, e.g. developed into a plug, to an end-user, comprising delivering the sealed container to a home.

14. A holder strip comprising a row of holders formed by cavities for receiving a plug or plant, the row extending in a joining direction, the cavities having a depth extending in a longitudinal direction perpendicular to the joining direction, wherein the cavities each have a wall surrounding the cavity and having two or more removal slits interspersing the wall, the slits extending in the longitudinal direction starting at the top of the cavity, arranged to allow an operator to engage an object placed inside the cavity and to remove it from the cavity via a motion in the longitudinal direction, wherein each removal slit has a length larger than 30 percent of the length of the wall in the joining direction.

15. The holder according to claim 14, wherein
a breakable bridge connect two adjacent cavities; and/or
each holder has a bottom, wherein the bottom has one or more draining holes formed in its surface; and/or
the at least two removal slits are formed on opposite sides of a cavity.

16. A packaging- and shipping system comprising a container and a holder, the holder receivable by the container;
wherein the holder has one or more cavities, formed in a longitudinal direction, for receiving a plug and/or plant;
wherein the container comprising a bottom surface and a wall forming a receiving space for holding the one or multiple holders, wherein a perforated foil can seal off the receiving space,
wherein the container and holder have an engaging system arranged to detachably fix the one or multiple holders in the receiving space, the engaging system being arranged to hold the one or multiple holders with the longitudinal direction generally extending along the bottom.

17. A packaging- and shipping method comprising:
providing a container, perforated foil, a seed, seedling, plant or plant cutting, holder, the holder having one or more cavities;
placing the seed, seedling, plant or plant cutting in one of the one or more cavities of the holder;
detachably clamp the holder in the container,
sealing off the container with perforated foil and
shipping the packaging tray.

18. The packaging- and shipping method of claim 17, wherein the method further comprises breaking a breakable bridge of the holder that connects two adjacent cavities.
